(19) United States
(12) Patent Application Publication
(10) Pub. No.: US 2009/0237813 A1
(43) Pub. Date: Sep. 24, 2009

(54) WIRELESS COMMUNICATION DEVICE WITH MAGNIFYING LENS

(76) Inventor: Giora Erlich, North Caldwell, NJ (US)

Correspondence Address: ABELMAN, FRAYNE & SCHWAB, 666 THIRD AVENUE, 10TH FLOOR, NEW YORK, NY, 10017, US

(21) Appl. No.: 12/052,993

(22) Filed: Mar. 21, 2008

(51) Int. Cl. G02B 25/02; G02B 25/00

(52) U.S. Cl. 359/809; 359/802

(57) ABSTRACT

A wireless communication device, preferably in the form of a telephone having a housing and an information display screen for displaying information associated with at least wireless communications, wherein the information display screen is positioned on a surface of the housing. A magnifying lens is mounted in a first position with respect to the information display screen for magnifying information displayed on the information display screen. A user can adjust the magnifying lens to a second position that is distally located from the information display screen for magnifying objects distally located from the wireless communication device.

### FIELD OF THE INVENTION

The present invention relates to a wireless communication device, and more specifically, a wireless communication device equipped with a magnifying lens for enabling a user to magnify objects displayed on the information display screen, as well as objects located distally from the display screen.

### BACKGROUND OF THE INVENTION

Cellular phones, personal digital assistants (PDAs) and other mobile communication devices have become ubiquitous electronic devices for enhancing personal communications. These devices not only provide audio communications, but have been augmented with other features and devices, such as cameras, video players, web browsers and video games, among others to enhance the user's ability to communicate with, and be entertained by, the mobile device.

Although mobile devices have been vastly improved in terms of being much more user friendly, having better reception, including more features, and a smaller size that makes them more convenient to transport, some of the features can have drawbacks during operation. For example, the relatively small display screen is often difficult to view or read, especially for those with vision impairments.

U.S. Pat. No. 6,985,311 to Bartone discloses a flip-top cellular phone having a top display screen portion which is hinged to a base portion (with a keypad) in a foldable arrangement in a well known manner. A thin magnifying film, such as a Fresnel lens, is secured to the top portion over the display screen by a pair of cantilever springs. The cantilever springs are biased in an extended position, wherein the springs automatically pop outward when the lid is opened to support the magnifying film at a desired magnifying distance from the screen. The magnifying distance may be determined by the focal point of the magnifying film and the needs of the user. However, by this arrangement, the magnifying lens is limited for only viewing information displayed on the display screen of the cellular phone, as opposed to objects that are positioned laterally with respect to the cellular phone. In addition, the lens and cantilever springs can become an irritant to a user when the top portion of the cellular phone is placed close to the ear of the user during use.

Although the flip-screen magnifier described in the Bartone patent can be helpful to view the information shown on a display screen, individuals, such as those with impaired vision, often find a magnifying lens to be helpful for viewing written material (e.g., books, newspapers and the like) or other objects not associated with the display screen. However, many of these individuals also find it inconvenient to carry additional personal accessories such as a magnifying glass. Furthermore, the magnifying lens of the Bartone patent does not permit viewing of objects positioned laterally or adjacent with respect to the cellular telephone.

### SUMMARY OF THE INVENTION

The deficiencies of the prior art can be overcome, as well as other advantages described herein can be achieved, by providing a wireless communication device equipped with a magnifying lens that can be positioned over, as well as laterally with respect to the display screen of the device.

In one embodiment of the present invention, the wireless communication device includes a wireless telephone (hereinafter “phone” or “cell phone”) having a housing with a display screen for displaying information associated with wireless communications, among other telephone and communication features. The display screen is positioned on a surface of the housing. A magnifying lens is mounted in a first position over the display screen for magnifying information displayed on the display screen. A user can adjust (i.e., move) the magnifying lens to a second position that is distally located from the display screen for magnifying objects distally located from the wireless communication device. The housing can be in the form of a cellular telephone, a personal digital assistant, or any other portable electronic communications device. In the instance where the device is a cellular telephone, the housing can be a drawer type cellular phone, a candy bar type cellular phone, or a flip-top cellular phone, among other configurations of cellular phones.

The magnifying lens can be fabricated from plastic or glass. The magnifying lens can be a Fresnel lens or any other type of magnifying device. A Fresnel lens is a thin optical lens consisting of concentric rings of segmental lenses having a short focal length.

In one embodiment, the magnifying lens is mounted to the housing by a hinge. The hinge facilitates rotation of the magnifying lens between the first and second positions. The magnifying lens can be rotated by a user about the hinge at least about 45 degrees or greater with respect to the display screen. Preferably, the magnifying lens can be rotated by a user about the hinge at least 180 degrees.

In another embodiment, the display screen is recessed within the housing, and the magnifying lens is slidably mounted over the display screen. In this embodiment, the housing. The housing comprises a pair of opposed channels (i.e., an upper channel and a lower channel), which are formed above and below the display screen. The magnifying lens is slidably mounted between the pair of opposed channels. A slot is formed along a sidewall of the housing, and the slot is aligned between the pair of opposed channels and has a length less that the distance between the pair of opposing channels.

The magnifying lens can include a pair of axially aligned pins formed on a first end of the magnifying lens that respectively extend within the channels. The magnifying lens is positioned over the display screen in the first position, and slidably extends through the slot at the second position to view objects distal from the housing.

In one embodiment, the housing includes at least one biasing spring positioned along a sidewall opposite the sidewall with the slot and adjacent the display screen. The biasing spring is compressed in response to a force directing the magnifying lens inward over the display screen, and expands outward upon removal of the force to thereby slide the magnifying lens to the second position.

In yet another embodiment, the magnifying lens is mounted to the housing over the display screen by a pin. The pin facilitates rotation of the magnifying lens between the first position over the display screen and the second position for viewing object distal from the housing. Preferably, the pin is positioned above the display screen and the magnifying lens can be rotated 180 degrees about the pin.

For any of the lens mounting techniques described hereinabove, the communications device preferably includes a light emitting element mounted to the back surface of the housing for illuminating the object to be viewed through the lens. A switch is mounted to the housing and is electrically coupled to the light emitting source for providing power to the light emitting element from a power source. The light emitting element is preferably a light emitting diode, although other light emitting elements can be provided, such as a photovoltaic cell, an incandescent bulb, fiber optics, and the like. In one embodiment, the display screen includes a light emitting device for illuminating objects when the magnifying lens is positioned in the second position.

Accordingly, the present invention provides a wireless communication device that is equipped with a magnifying lens for conveniently magnifying information shown on a display screen without irritating the user while communicating with the device. The present invention also provides a wireless communication device that is equipped with a magnifying lens for magnifying objects that are not associated with the display screen of the wireless communication device.

### BRIEF DESCRIPTION OF THE DRAWINGS

The teachings of the present invention can be readily understood by considering the following detailed description in conjunction with the accompanying drawings, in which:

FIG. 1 is a top, front and right side perspective view of a flip-type cellular telephone, in a closed position, and illustrating a first embodiment of a magnifying lens of the present invention;

FIG. 2 is a cross-sectional view of the cellular telephone taken along the line 2-2 of FIG. 1;

FIG. 3 is a front elevational view of the cellular phone of FIG. 1, in an open position, illustrating the magnifying lens positioned over the display screen;

FIG. 4 is a partial cross-sectional view of the cellular phone taken along line 4-4 of FIG. 3;

FIG. 5 is a perspective view of the cellular phone of FIG. 1, illustrating the magnifying lens in use for reading text that is positioned externally from the display screen;

FIG. 6 is a perspective view of the cellular phone of FIG. 1, illustrating the magnifying lens in use for viewing a small object positioned externally from the display screen;

FIG. 7 is a top, front and right side perspective view of a cellular phone arranged in an open position and equipped with a second embodiment of the magnifying lens of the present invention;

FIG. 8 is a top, front and right side perspective view of a cellular phone arranged in an open position and equipped with a third embodiment of the magnifying lens of the present invention;

FIG. 9 is a top, front and right side perspective view of a magnifying lens having a universal pivoting connector for attachment and detachment with a cellular phone;

FIG. 10 is a top, front and right side perspective view of the magnifying lens attached to a cellular phone by the universal pivoting connector;

FIG. 11 is a partial cross-sectional view of the cellular phone and magnifying lens taken along line 11-11 of FIG. 10; and

FIG. 12 is a top, front and right side perspective view of a carrying case for carrying a candy bar type cellular phone and magnifying lens on the belt of a user.

To facilitate an understanding of the invention, the same reference numerals have been used, when appropriate, to designate the same or similar elements that are common to the figures. Unless stated otherwise, the features shown and described in the figures are not drawn to scale, but are shown for illustrative purposes only.

### DETAILED DESCRIPTION OF THE PREFERRED EMBODIMENT

Although the present invention is described herein with reference to a cellular telephone, it should be understood that the apparatus of the present invention may be used on other electronic mobile communication devices, such as a personal digital assistant (PDA, e.g., a BLACKBERRY® communications device), a handheld computer or a video game player among other mobile communication devices. In addition, while the present invention will be described with reference to a folding type (i.e., flip-cover, flip-top or clamshell) cellular phone, those skilled in the art for which the invention pertains will appreciate that the present invention is applicable to other types of cellular phones, such as non flip-type candy bar phones, ultra-thin phones (e.g., RAZR®) or flip-cover slider phones, among other types of cellular phones and mobile communication devices.

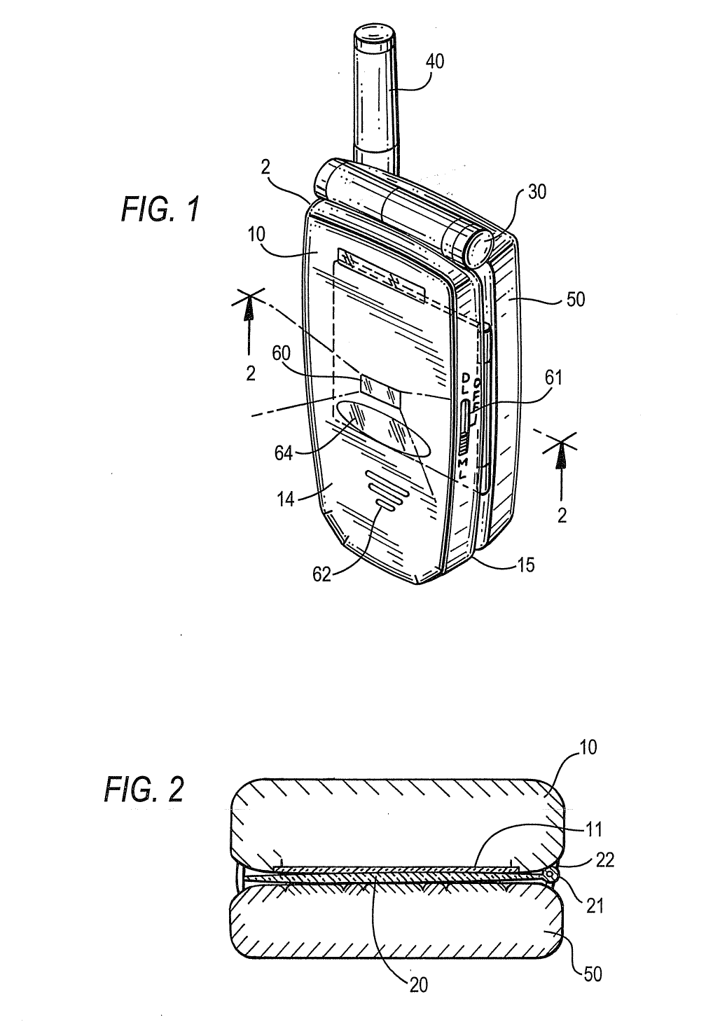

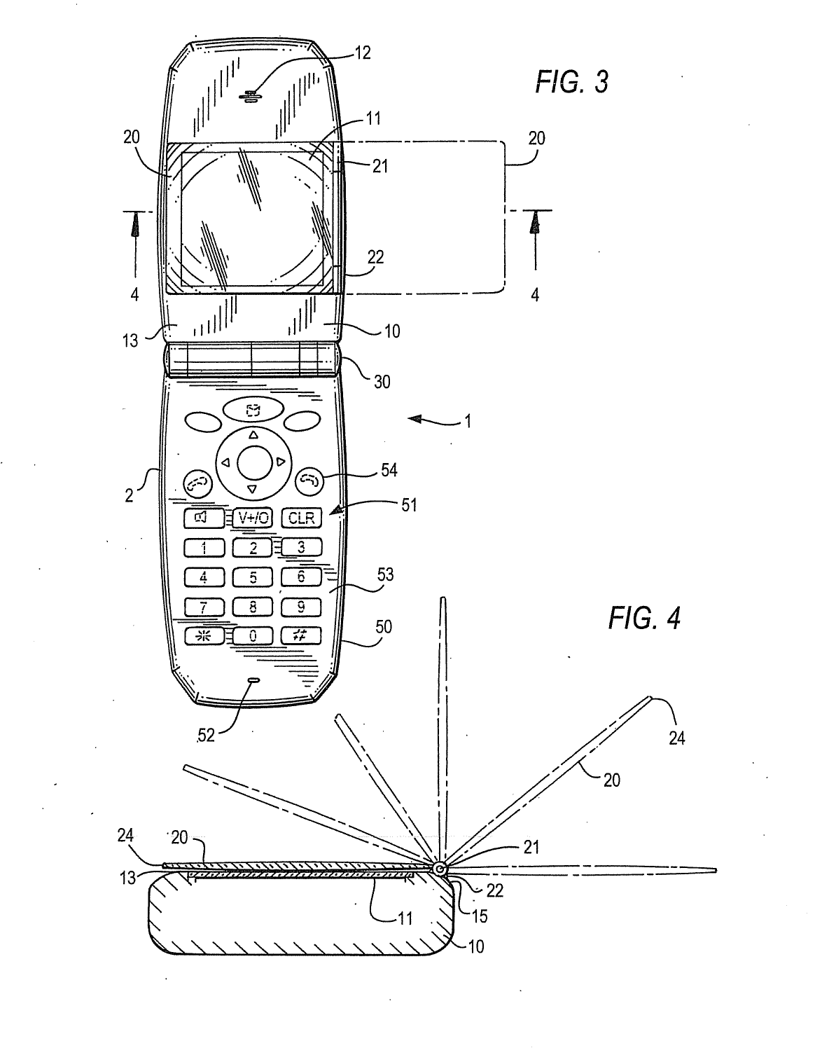

Referring to the drawings, FIGS. 1-2 illustrate a folding-type cellular telephone 1 in a closed position, and FIG. 3 illustrates the cellular phone 1 in an open position. The folding type cellular telephone 1 includes a housing 2 having a base portion 50 coupled (e.g., rotatably coupled) to a top or lid portion 10.

The base portion 50 and top portion 10 of the folding-type phone 1 are connected to each other by at least one hinge 30 to permit rotation between the open and closed positions of the cellular phone 1 in a well known manner. One skilled in the art for which the invention pertains will appreciate that the fastener used to couple the top or lid portion 10 to the base portion 50 is dependent on the style of the cellular telephone.

The base portion 50 houses a battery (not shown) to provide power to the cellular telephone 1. Preferably, the battery is a rechargeable battery, although conventional non-rechargeable batteries can be utilized. A power switch 54 (FIG. 3) is electrically connected between the battery and internal circuitry (not shown) of the cellular phone to turn the cellular phone on and off. The internal circuitry facilitates wireless communications with other communication devices in a well known manner.

In one embodiment, an antenna 40 extends from the top surface of the base portion 50 to send and receive wireless communications with other cellular telephones or mobile devices. Alternatively, the antenna 40 can be provided (e.g., flush mounted) within the interior of the base portion 50 in a well known manner.

Referring again to FIG. 3, the base portion 50 further includes a keypad 51 having user selectable control keys, and a microphone 52, all of which are accessible to the user from the inner surface 53 of the base portion 50 in a well known manner. The top or lid portion 10 includes an information display screen 11 (i.e., a primary LCD display) and a speaker 12 positioned on the inner surface 13 of the top portion 10, which are accessible to the user in a well known manner.

Referring again to FIG. 1, the top portion 10 includes an outer cover 14, which can house an external secondary display panel 64, such as an LCD display. The LCD display 64 can display, for example, the time and/or the phone number of an incoming or outgoing call. A speaker 62 can also be mounted on the outer cover 14 for providing “hands-free” communications with the phone 1.

In FIG. 3, the cell phone includes a magnifying lens 20 mounted according to one embodiment of the present invention. The magnifying lens 20 may be any conventional lens, such as a convex lens fabricated from a transparent material such as glass or plastic. The magnifying lens 20 can be a thin, flat, lightweight plastic lens, such as a Fresnel or other type of magnifying lens. Preferably, the lens 20 has a length and width which is dimensioned to substantially correspond with the dimensions of the display screen 11. However, the shape and/or size of the lens 20 are not considered limiting.

In FIGS. 2-4, the magnifying lens 20 is rotatably secured to the top portion 10 by a hinge 21, which is mounted in a recess or curved edge 22 formed along the inner surface of the top portion 10. Preferably, the magnifying lens 20 is hinged to one of the lateral edges of the inner surface 13 of the top portion 10, as shown in FIGS. 2-4. Referring to FIG. 3, although the magnifying lens 20 is illustratively hinged to the right lateral edge along the inner surface 13 of the top portion 10, a person skilled in the art for which the invention pertains will appreciate that the mounting location is not considered limiting.

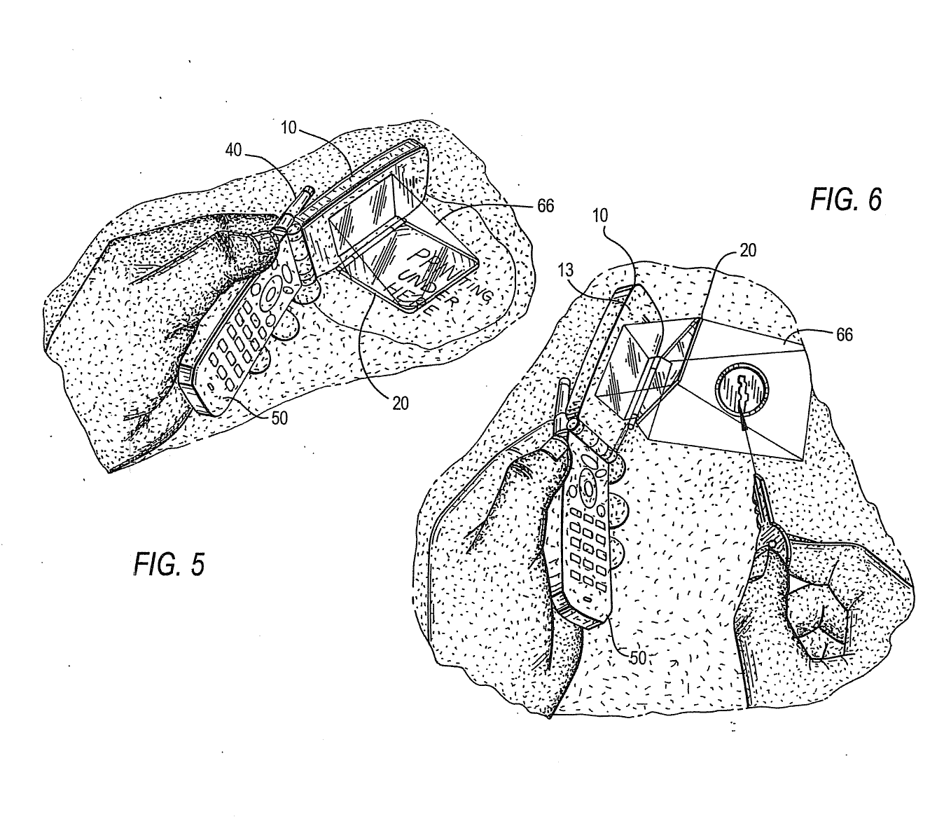

Referring now to FIGS. 4-6, the magnifying lens 20 is illustratively shown being pivoted a selective angle with respect to the inner surface 13 of the top portion 10, such that the lens is displaced from the primary display screen 11. In this manner, the user can view objects off the screen, as shown in FIGS. 5 and 6.

Referring to FIG. 4, a cross-sectional view of the top portion 10 of the cell phone along line 4-4 of FIG. 3 is shown. One end of the magnifying lens 20 is rotatably attached by the hinge 21, which extends along the recess 22 formed along the lateral side of the inner surface 13 of the top portion 10 of the phone 1. Preferably, the user can manually rotate the magnifying lens 20 at least one-hundred and eighty degrees (180°) with respect to the display screen 11 which forms the inner surface 13 of the top portion 10.

In one embodiment as shown in FIG. 3, the user can rotate the magnifying lens 20 at an angle away from the display screen 11 by grasping the free end 24 of the lens opposing the hinge 21, and then rotating the lens 20, as illustrated by the rotated lens positions shown in phantom. The magnifying lens 20 is returned to its non-extending state in a similar manner by rotating the lens in the opposite direction back over the display screen 11. Although not shown in FIG. 4, a person skilled in the art will appreciate that the magnifying lens 20 can be rotated more than 180 degrees, that is, from the non-extended position over the display screen 11 to a position that extends until the lens 20 comes into contact with the external side wall 15 of the top cover 10. Accordingly, the magnifying lens 20 can be used to magnify information displayed on the display screen 11 when the lens 20 is positioned over the display screen 11. Further, the magnifying lens 20 can be used to magnify an object near the cellular phone 1 when the lens 20 is rotated away from the display screen 11.

Referring now to FIGS. 5 and 6, the angle of the magnifying lens 20 can be easily adjusted such that a user can conveniently view an object positioned distally from the cellular phone 1. In FIG. 5, the magnifying lens 20 is shown rotated approximately 90 degrees with respect to the display screen 11 to view, for example, text that is written on a document or book. In FIG. 6, the lens 20 is illustratively shown as being rotated approximately 45 degrees to magnify a non-text object, such as keyhole or any other object requiring magnification by the user.

In one embodiment, the display screen 11 can be used as a source of light 66 to provide illumination through the lens to assist the user in better viewing an object (e.g., text). Referring to FIG. 1, an on/off switch 61 is mounted on the side of the top portion 10 of the cellular phone 1. In one embodiment, the light switch 61 can be used to turn the display screen light on in conjunction with or independently of the magnifying lens 20. The light 66 emitted from the display screen 11 radiates through the lens 20 when extended up to approximately 90 degrees to help illuminate and magnify an object for viewing, for example, in the dark.

In a preferred embodiment, a secondary light source, such as a light emitting diode (LED) 60 is mounted on the outer surface of the top portion 10, although other light emitting sources can be implemented, such as an incandescent bulb, photovoltaic devices or fiber optics, among other light emitting devices. The light radiating from the secondary light source 60 helps to enable the user to view distal objects by illuminating an object directly, without the light passing through the magnifying lens 20. The on-off switch 61 is electrically coupled between the LED 60 and the battery of the cellular phone 1 to manually turn the LED 60 on and off. Although the on-off switch 61 is illustratively installed on a sidewall of the top portion 10, a person skilled in the art will appreciate that both the switch 61 as well as the LED 60 can be positioned at other convenient locations on the housing 2 of the cellular phone 1, such as the outer surface of the base portion 50.

Referring again to FIG. 1, preferably the switch 61 is a three-way switch mounted on the outer cover 14 of the cellular phone 1. The switch 61 can be manually set from a central “off” position to a first “on” position (e.g., labeled “DL”) to turn the light of the display screen 11 on continuously. In other words, the display screen power-saving feature of turning of the display screen light off after a predetermined time (e.g., fifteen or thirty seconds) is overridden.

Alternatively, the switch 61 can be manually set to a second “on” position to activate the secondary light source 60, either independently or in conjunction with using the magnifying lens (e.g., labeled “ML”). In this manner, the user can manually set the switch 61 to turn the secondary light source 60 “on” and then use the cellular telephone 1 as a “flashlight” to view and/or magnify distal objects.

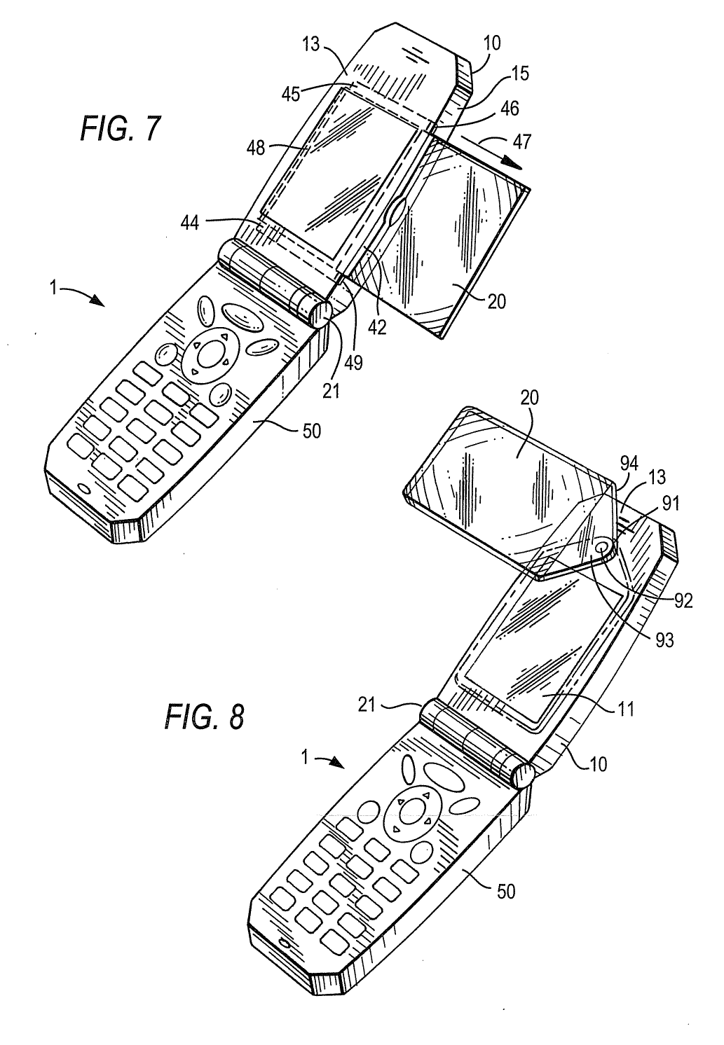

Referring to FIGS. 7 and 8, alternative embodiments of the magnifying lens 20 are illustratively shown. Referring to FIG. 7, the display screen 11 is recessed within the inner surface 13 of the top portion 10, and a lateral slot 42 having a substantially rectangular cross section is formed along the sidewall 15 of the top portion 10 over the display screen 11. The slot 42 is dimensioned to receive the magnifying lens 20 of the present invention.

A pair of lower and upper channels 44, 45, respectively, each having a rectangular cross-sectional shape is formed in the inner surface 13 of the outer cover 14. The upper channel 45 is formed above the display screen 11, and the lower channel 44 is formed below the display screen 11. The channels 44 extend inward from the lateral slot 42 to the opposing side 15 of the inner surface 13 away from the slot 42. The depth and width of the slot 42 and the pair of opposed channels 44, 45 are dimensioned such that the magnifying lens 20 can be slidably extended from and retracted over the display screen 11. Accordingly, the inner surface 13 and outer edge of the display screen 11 forms a pair of opposing tracks for retaining the magnifying lens 20.

Axially aligned upper pin 46 and lower pin 49 are each formed or mounted to an end of the magnifying lens 20. The pins can be fabricated from any semi-rigid material, such as plastic, metal, or other well-known material. The pins 46, 49 serve as guide pins within the channels 44, as well as end-stops to prevent the magnifying lens 20 from being pulled completely out of the slot 42. As described above, the upper channel is positioned above the slot 42 and the lower channel is positioned below the slot 42. The pins 46, 49 are dimensioned to extend within and slide along each channel (i.e., track) between the opposing sidewalls 15 of the top portion 10. When the magnifying lens 20 is in a fully extended position, the upper pin 46 abuts the interior surface of the sidewall 15 above the slot 42 and the lower pin abuts the interior surface of the sidewall 15 below the slot 42, since the length of the slot 42 is less than the combined length of the magnifying lens 20 and the guide pins 46, 49.

In one embodiment, the pins 46 are spring loaded for insertion into the slot 42 and channels 44. That is, the pins can be compressed inwardly towards each other to facilitate insertion of the magnifying lens 20 into the slot 42 and channels 44. Once the lens 20 is inserted through the slot 42, the spring loaded pins expand outward into the channels 44, thereby securing the magnifying lens 20 within the channels 44 and slot 42.

Alternatively, the pins 46 can be fixedly attached to the opposed end of the lens 20. In this embodiment, the lens 20 and pins 46 are positioned over the display screen 11 and channels 44, 45, respectively, prior to the inner surface 13 and outer cover 14 of the top portion 10 of the cellular phone 1 being assembled.

In one embodiment, the magnifying lens 20 can be extended from the display screen 11 by grasping the free end of the lens 20 and sliding the lens 20 outward in the direction illustrated by arrow 47. Alternatively, the magnifying lens 20 can be “spring loaded”, such that the user pushes the lens 20 inwardly in a direction opposite to arrow 47 in FIG. 7, and one or more biasing springs 48 compress and subsequently push the lens 20 outwardly through the slot 42. In this embodiment, the one or more biasing springs 48 are mounted along the interior surface of the sidewall 15 (e.g., the left sidewall shown in FIG. 7) which is located opposite the sidewall with the slot 42 formed therein. In either embodiment, the lens 20 is retracted manually over the display screen 11 by sliding (i.e., pushing) the lens 20 in the opposite direction of arrow 47, i.e., through the slot 42 and over the display screen 11.

In still another preferred embodiment, referring to FIG. 8, a pivot pin 92 is mounted on the inner surface 13 of the top portion 10, for example between the upper portion of the display screen 11 and below the speaker 12. In one embodiment, the magnifying lens 20 is sized to overlay the display screen 11 and includes an upper portion 94 that extends above the display screen 11. The upper portion 94 of the lens 20 includes an aperture 91 at a distal end 93 that is sized to receive the pivot pin 92. Preferably, the magnifying lens 20 can be rotated 360 degrees about the pivot pin 92. In this manner, the magnifying lens 20 can be positioned over the display screen 11 to permit the user to magnify the information displayed on the screen 11. Alternatively, the user can rotate the magnifying lens 20 about the pin 92 to magnify objects away from the display screen 11.

Although the magnifying lens 20 is illustratively shown as being centrally mounted over the display screen 11 via the pin 92, such pin position is not considered limiting, as the pin 92 and aperture pair 91 can be located, for example, proximate a sidewall 15. Further, a person skilled in the art will appreciate that the pin/aperture pair can be configured such that the pin is formed as a part of the magnifying lens 20 and the aperture 91 is formed on the inner surface 13 of the housing 2. Preferably, for either of the embodiments of FIGS. 7 and 8, the light source 60 is mounted to the outer cover 14 of the top portion 10 to permit the user to illuminate non-display screen objects, as described above with respect to FIGS. 1-6.

The present invention provides a wireless communication device (e.g., a cellular phone 1, personal digital assistant (PDA), and the like) that is equipped with a magnifying lens for conveniently magnifying information shown on a display screen without irritating the user during wireless communications. The magnifying lens is also configured to enable a user to magnify objects that are not associated with the display screen of the wireless communication device. Advantageously, the user can magnify objects distally located from the communication device without having to carry a separate magnifying device.

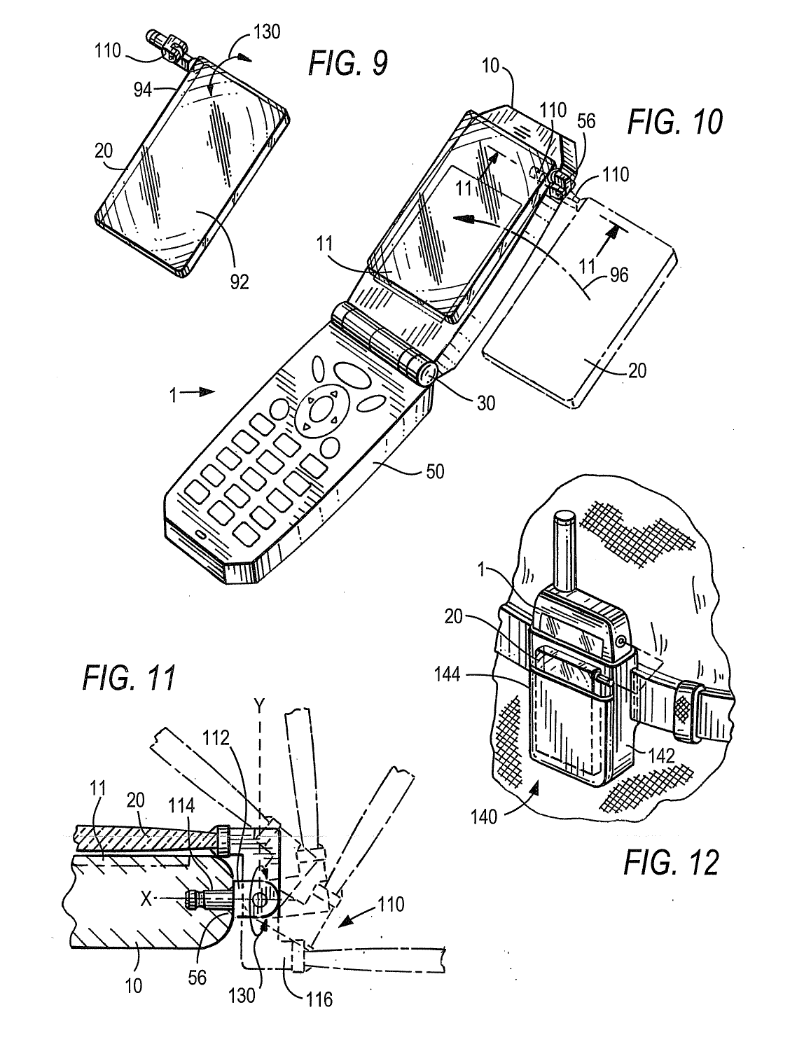

Referring to FIG. 9, another embodiment of a magnifying lens 20 that can be attached to the housing 2 of the cellular phone 1 is shown. The magnifying lens 20 includes a universal pivoting connector 110 that can be inserted into an opening such as the earphone jack on the housing 2 of the cellular phone 1. Accordingly, the magnifying lens 20 of FIG. 9 can be considered an accessory component that is provided with the cellular phone 1 or available as an after-market accessory.

The magnifying lens 20 includes the lens portion 92 having a peripheral edge 94, such as a pair of opposed lateral edges and opposed top and bottom edges. As shown in FIG. 9, the universal pivoting connector 110 is, for example, attached to the left peripheral edge and proximate the upper edge, although the location for attachment thereof is not considered limiting.

Referring now to FIG. 10, the magnifying lens 20 of FIG. 9 illustratively shown coupled to the cellular phone 1. Specifically, one end of the universal pivoting connector 110 is inserted into a port, for example, the earphone jack 56 formed in the housing 2 (e.g., the top portion 10) of the cellular phone 1. The universal pivoting connector 110 allows the user to manually rotate the magnifying lens 20 approximately 180 degrees or greater with respect to the information display screen 11. The magnifying lens 20 is illustratively shown in a first position lateral to the information display screen 11 (drawn in phantom in FIG. 10) and rotated about 180 degrees over the information display screen 11, as depicted by the arrow 96.

Referring to FIG. 11, a partial cross sectional view of the magnifying lens 20 and universal pivoting connector 110 is shown inserted into the earphone jack 56 of the cellular phone 1 along line 11-11 of FIG. 10. The universal pivoting connector 110 enables the user to manually adjust the positioning of the magnifying lens 20 with respect to the cellular phone 1 along two perpendicular axes such as an X-axis and a Y-axis.

In one embodiment, the universal pivoting connector 110 includes a first member 112 rotatably attached to a second member 116 via a pin 120. The first member 113 includes a shaft 114 forming a first end of the first member, and the shaft is dimensioned to be inserted and secured, for example, in the earphone jack 56 of the cellular phone 1, illustratively along the X-axis. Preferably, the first member 112 of the pivoting connector 110 can rotate about the shaft 114 along the X-axis three-hundred and sixty (360) degrees, as illustrated by arrow 120. Preferably the second member 116 is L-shaped such that a first end 118 of the second member 116 is rotatably attached to an opposed second end of the first member 112.

Furthermore, a second end 122 of the second member 116 is attached to the peripheral edge 94 of the magnifying lens 20. In one embodiment, the second end 122 of the second member 116 is fixedly attached to the magnifying lens 20. Preferably, the second end 122 of the second member 116 is rotatably attached to the magnifying lens 20, for example, by a ball joint. In this manner, the magnifying lens can be rotated about the X-axis along the shaft 114 by rotating either the first member 114 about the shaft 114 or the magnifying lens 20 about the second end 122 of the second member 116.

Moreover, the connection of the first member 112 with the second member 116 via the pin 120 permits the user to rotate the second member 116 and, therefore, the magnifying lens with respect to the first member approximately one-hundred and eighty (180) degrees or greater, as illustratively drawn in phantom in FIG. 11.

Referring now to FIG. 12, a carrying case 140 is shown having a first pocket 142 having a dimension for retaining the cellular phone 1, and a second pocket 144 formed over the first pocket 142 that is dimensioned to retain the magnifying lens 20. In this manner, the user can conveniently carry both the cellular phone 1 and magnifying lens 20, for example, on or clipped to the belt of the user. The user can remove and use the either the cellular phone 1 or the magnifying lens 20 independently as separate components, as well as attach the magnifying lens 20 to the cellular phone 1 in a manner described above.

Although various embodiments that incorporate the teachings of the present invention have been shown and described in detail herein, those skilled in the art can readily devise many other varied embodiments that still incorporate these teachings.

I claim:

1. A wireless communication device comprising:
a telephone having a housing and a display screen for displaying information associated with at least wireless communications, said display screen being positioned on a surface of said housing; and
a magnifying lens mounted in a first position with respect to said display screen for magnifying information displayed on said display screen, and movable to a second position distally located from said display screen for magnifying objects distally located from said wireless communication device.

2. The device of claim 1, wherein the magnifying lens is mounted to said housing and over said information display screen by a hinge, said hinge facilitating rotation of said magnifying lens between said first and second positions.

3. The device of claim 2, wherein said magnifying lens rotates about the hinge at least 45 degrees with respect to the display screen.

4. The device of claim 2, wherein said magnifying lens rotates about the hinge at least 180 degrees with respect to the display screen.

5. The device of claim 1, wherein the magnifying lens is slidably mounted over said display screen.

6. The device of claim 5, wherein said housing comprises:
a pair of opposed channels formed above and below said display screen, said display screen being recessed within said housing, and said magnifying lens being slidably mounted between said pair of opposing channels; and
a slot formed along a sidewall of said housing, said slot being aligned between said pair of opposing channels and having a length less that the distance between said pair of opposing channels.

7. The device of claim 6, wherein said magnifying lens includes a pair of axially aligned pins formed on a first end of said magnifying lens and respectively extending within said channels.

8. The device of claim 7, wherein said magnifying lens is positioned over said display screen in said first position, and slidably extends through said slot at said second position.

9. The device of claim 8, wherein said housing includes at least one biasing spring positioned along a sidewall opposite of said sidewall with said slot and adjacent said display screen, said biasing spring being compressed in response to a force directing said magnifying lens inward over the display screen, and expanding outward upon removal of said force to thereby slide said magnifying lens to said second position.

10. The device of claim 1, wherein the magnifying lens is mounted to said housing by a pin, said pin facilitating rotation of said magnifying lens between said first and second positions.

11. The device of claim 10, wherein said magnifying lens is rotatable 180 degrees about said pin.

12. The device of claim 1, wherein said pin is positioned above said display screen.

13. The device of claim 1, further comprising:
a light emitting element mounted to a back surface of the housing for illuminating the object to be viewed through the lens; and
a switch mounted to the housing and electrically coupled to the light emitting element for providing power to the light emitting element from a power source.

14. The device of claim 13, further comprising:
a primary light emitting device for emitting light through said information display screen;
a secondary light emitting device for emitting light from said housing towards a distally located object; and
a switch positioned on said housing and electrically coupled to activate at least one of said primary and secondary light emitting devices.

15. The device of claim 12, wherein said light emitting element is selected from the group of light emitting devices consisting of a light emitting diode, a photovoltaic cell, an incandescent bulb, and fiber optics.

16. The device of claim 1, wherein said display screen includes a light emitting device for illuminating objects when said magnifying lens is positioned in said second position.

17. The device of claim 1, wherein said magnifying lens is a Fresnel lens.

18. The device of claim 1, wherein the housing is a drawer type cellular phone.

19. The device of claim 1, wherein the housing is a candy bar type cellular phone.

20. The device of claim 1, wherein the housing is a flip-top cellular phone.

21. A wireless communication device including wireless communications circuitry comprising:
a housing for facilitating said wireless communications circuitry, and having an information display screen mounted on a front surface of said housing; and
a magnifying lens rotatably mounted over said information display screen, said magnifying lens being rotatably mounted by a pin extending through said magnifying lens and the front surface of said housing, wherein said magnifying lens is movably positioned in a first position for viewing contents over said information display screen, and positioned distally from said information display screen in a second position to view objects distal from said information display screen.

22. A wireless communication device having communications circuitry and an information display screen comprising:
a housing including a sidewall having a lateral slot and a pair of opposed channels extending longitudinally inward from the aperture above and below said display screen; and
a magnifying lens mounted slidably longitudinally along the opposed channels within the housing, said lens being inserted within the lateral slot in a first position when magnifying information on said display screen, and slidably extending through the lateral slot in a second position for magnifying objects distal from said housing.

23. A wireless communication device including wireless communications circuitry comprising:
a housing for supporting said wireless communications circuitry and having an information display screen mounted on a front surface of said housing; and
a magnifying lens having a multi-axis pivoting connector coupled to an edge of said magnifying lens, said multi-axis pivoting connector having a shaft dimensioned for insertion into said housing aperture and rotatable along a first axis, said multi-axis pivoting connector having a hinge for rotating said magnifying lens along a second axis over and distally away from said information display screen.

24. Apparatus for holding a wireless communication device including wireless communications circuitry comprising:
a housing for facilitating said wireless communications circuitry and having an information display screen mounted on a front surface of said housing; and
a magnifying lens having a multi-axis pivoting connector coupled to an edge of said magnifying lens, said multi-axis pivoting connector having a shaft dimensioned for insertion into said housing aperture and rotatable along a first axis, said multi-axis pivoting connector having a hinge for rotating said magnifying lens along a second axis over and distally away from said information display screen.

25. Magnifying lens for magnifying objects over and distally from an information display screen of a cellular phone comprising:
a lens portion having a peripheral edge;
a multi-axis pivoting connector coupled to said peripheral edge of said magnifying lens; said multi-axis pivoting connector having a first member rotatably attached to a second member, said first member having a shaft defining a first end of said first member and dimensioned for insertion into an aperture formed on a housing of said cellular phone, said second member being an L-shaped hinge having a first end rotatably attached to an opposed second end of said first member via a pin, and a second end of said second member being coupled to said peripheral edge of said lens portion, wherein said first member of said pivoting connector rotates about said shaft along a first axis, and said second member of said pivoting connector rotates about said pin along a second axis that is perpendicular to said first axis.

26. The magnifying lens of claim 25, wherein said second end of said second member is rotatably attached to said peripheral edge of said lens portion.

27. A carrying case for a cellular telephone having a removable magnifying lens comprising:
a first pocket dimensioned to receive said cellular telephone; and
a second pocket formed adjacent said first pocket, said second pocket being dimensioned to receive said removable magnifying lens.
